(19) United States
(12) Patent Application Publication
(10) Pub. No.: US 2009/0251296 A1
(43) Pub. Date: Oct. 8, 2009

(54) Methods and Systems for Managing and Reporting Micro-Production of Consumable Energy

(76) Inventor: James R. Whelan, JR., Ridgefield, CT (US)

Correspondence Address: WIGGIN AND DANA LLP;ATTENTION: PATENT DOCKETING, ONE CENTURY TOWER, P.O. BOX 1832, NEW HAVEN, CT, 06508-1832, US

(21) Appl. No.: 12/417,715

(22) Filed: Apr. 3, 2009

Related U.S. Application Data
(60) Provisional application No. 61/042,100, filed on Apr. 3, 2008.

(51) Int. Cl. H04Q 5/22; A63B 71/00

(52) U.S. Cl. 340/10.51; 482/2

(57) ABSTRACT

Methods and systems of capturing and reporting information related to the micro-generation of consumable electricity are disclosed. Some methods and systems include the following: attaching an electricity generation unit to a human-powered piece of exercise equipment, the electricity generation unit being adapted to generate consumable energy and capture information related to the consumable electricity generated; attaching a radio frequency identification writer to the electricity generation unit for capturing and conveying information related to the consumable electricity generated by the electricity generation unit; providing a radio frequency identification tag; conveying the information from the electricity generation unit to the radio frequency identification tag via the radio frequency identification writer; conveying the information directly from the electricity generation unit to a database; and transferring the information stored on the radio frequency identification tag to the database.

### CROSS REFERENCE TO RELATED APPLICATION(S)

This application claims the benefit of U.S. Provisional Application No. 61/042,100, filed Apr. 3, 2008, which is incorporated by reference as if disclosed herein in its entirety.

### BACKGROUND

Exercise equipment is used in over 30,000 health clubs, corporate fitness centers, universities/educational facilities, and planned communities across the country. The energy output produced by users of such exercise equipment is currently wasted. With the exception of various minor pilot projects, the energy output of a user of exercise equipment is not currently converted to usable electrical output, stored, and used. If captured and stored, the electrical output generated by users of exercise can be used by the facility that houses the exercise equipment, or in the case of excess electrical output, can be sold back to the electric utility.

In order to properly account for the energy generated and to provide additional motivation to users via feedback, a robust information system for capturing information related to the measurement of generated electrical output, particularly electrical output that is in excess of what is needed by the facility in which the output is generated, is required. Such excess power output can be sold back to the electric utility using Net Metering. The information system can also provide a monitoring system for the capture of Renewable Energy Certificates, which can be traded on the open market for those companies wishing to purchase clean energy. The information system can also be accessible by individual users to help motivate the users to utilize the exercise equipment on a more frequent basis.

### BRIEF SUMMARY

Methods of capturing and reporting information related to the micro-generation of consumable electricity are disclosed. Some methods include the following: attaching an electricity generation unit to a human-powered piece of exercise equipment, the electricity generation unit being adapted to generate consumable energy and capture information related to the consumable electricity generated; attaching a radio frequency identification writer to the electricity generation unit for capturing and conveying information related to the consumable electricity generated by the electricity generation unit; providing a radio frequency identification tag; conveying the information from the electricity generation unit to the radio frequency identification tag via the radio frequency identification writer; conveying the information directly from the electricity generation unit to a database; and transferring the information stored on the radio frequency identification tag to the database.

Methods of capturing and reporting information related to the micro-generation of consumable electricity are disclosed. Some methods include the following: attaching an electricity generation unit to a human-powered piece of exercise equipment, the electricity generation unit being adapted to generate consumable energy and capture information related to the consumable electricity generated; attaching a radio frequency identification writer to the electricity generation unit for capturing and conveying information related to the consumable electricity generated by the electricity generation unit; providing a radio frequency identification tag including a user identification number; automatically conveying the user identification number to the electricity generation unit via the radio frequency identification writer; and conveying the information and the user identification number from the electricity generation unit directly to a database

Systems for capturing and reporting information related to the micro-generation of consumable electricity are disclosed. Some systems include the following: an energy generation module including an electricity generation unit joined with a human-powered piece of exercise equipment, the electricity generation unit being adapted to generate consumable electricity and capture information related to the consumable electricity generated; a data capture module including a radio frequency identification writer joined with the electricity generation unit, the radio frequency identification writer being used to capture and convey information related to the consumable electricity generated by the electricity generation unit; an individual user data module including a radio frequency identification tag to be associated with an individual user, the radio frequency identification tag being adapted to receive information from the electricity generation unit via the radio frequency identification writer; a database for receiving the information stored on the radio frequency identification tag; and a direct reporting module including a communication conduit for conveying the information directly from the electricity generation unit to the database.

### BRIEF DESCRIPTION OF THE DRAWINGS

The drawings show embodiments of the disclosed subject matter for the purpose of illustrating the invention. However, it should be understood that the present application is not limited to the precise arrangements and instrumentalities shown in the drawings, wherein:

FIG. 1 is a diagram of a system according to some embodiments of the disclosed subject matter;

FIG. 2 is a diagram of a system according to some embodiments of the disclosed subject matter;

FIG. 3 is a diagram of a method according to some embodiments of the disclosed subject matter;

FIG. 4 is a diagram of a method according to some embodiments of the disclosed subject matter;

FIG. 5 is a schematic diagram of a system according to some embodiments of the disclosed subject matter;

FIG. 6 is a schematic diagram of a method according to some embodiments of the disclosed subject matter;

FIG. 7 is a schematic diagram of a display according to some embodiments of the disclosed subject matter; and

FIGS. 8-12 are various views of an exercise bicycle including an electricity generation unit according to some embodiments of the disclosed subject matter.

### DETAILED DESCRIPTION

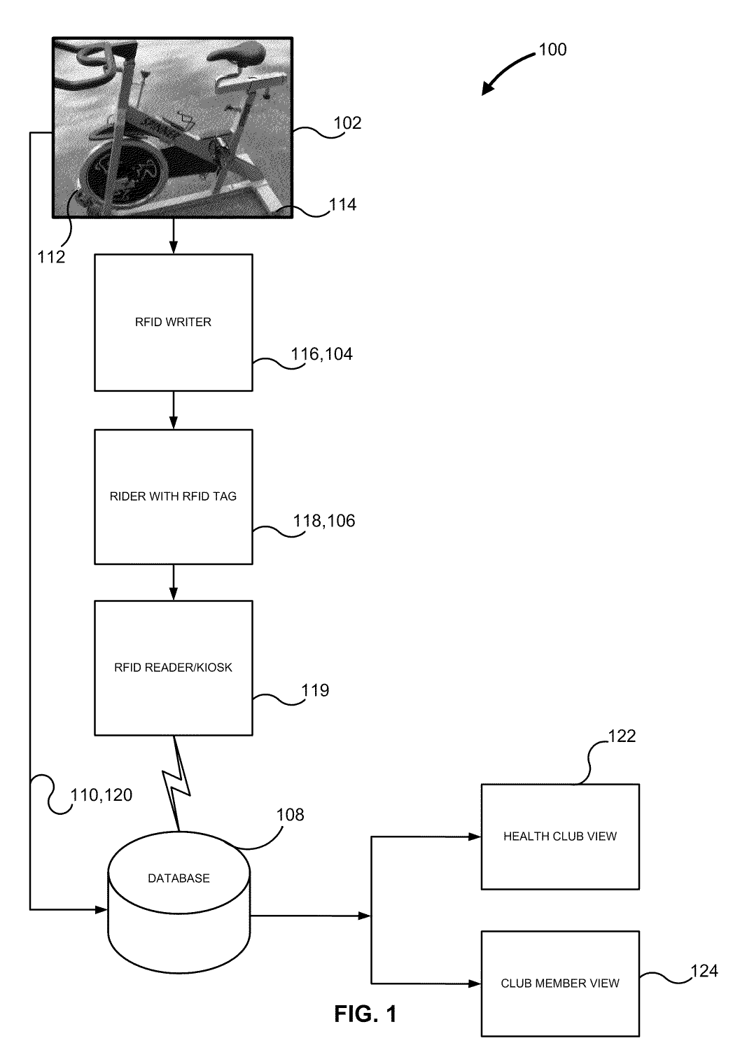

Referring now to FIG. 1, some embodiments of the disclosed subject matter include a system 100 for capturing and reporting information related to the micro-generation of consumable electricity. System 100 includes an energy generation module 102, a data capture module 104, an individual user data module 106, a database 108, and a direct reporting module 110.

Energy generation module 102 includes an electricity generation unit 112 joined with a human-powered piece of exercise equipment 114. Electricity generation unit 112 is adapted to generate consumable electricity and capture information related to the consumable electricity generated.

Data capture module 104 includes a radio frequency identification writer 116 joined with electricity generation unit 112. Radio frequency identification writer 116 is used to capture and convey information related to the consumable electricity generated by electricity generation unit 112.

Individual user data module 106 includes a radio frequency identification tag 118 to be associated with an individual user. Radio frequency identification tag 118 is adapted to receive information from electricity generation unit 112 via radio frequency identification writer 116.

Database 108 is used to receive information stored on radio frequency identification tag 118. Database 108 can receive information via a wired or wireless network and via the Internet or any other known ways for conveying data. In some embodiments, data from radio frequency identification tag 118 is scanned using a from radio frequency identification 119. The scanned data is transmitted to database 108 and radio frequency identification tag 118 is cleared.

Direct reporting module 110 includes a communication conduit 120 for conveying information directly from electricity generation unit 112 to database 108. For example, communication conduit 120 can be a wired or wireless network or any other known technology for conveying data to a database.

Other aspects of system 100 include algorithms for processing data and a user interface (not shown) for accessing and viewing data collected and stored in database 108. It is anticipated that data collected and stored in database 108 will be presented to various users in different forms. For example, the owner of a health club can be presented with a health club view 122 that includes the following information: Class; Daily, weekly, monthly, yearly or user defined periods of the following: Equipment used [min, max, average]; energy produced [min, max, average]; work-out duration [min, max, average]; CO2 savings; Renewable Energy Certificates (RECs) generated; and income from RECs. A health club member can be presented with a club member view 124 that includes the following information: Class; Daily, weekly, monthly, yearly or user defined periods of: energy produced [min, max, average]; work-out duration [min, max, average]; and CO2 savings.

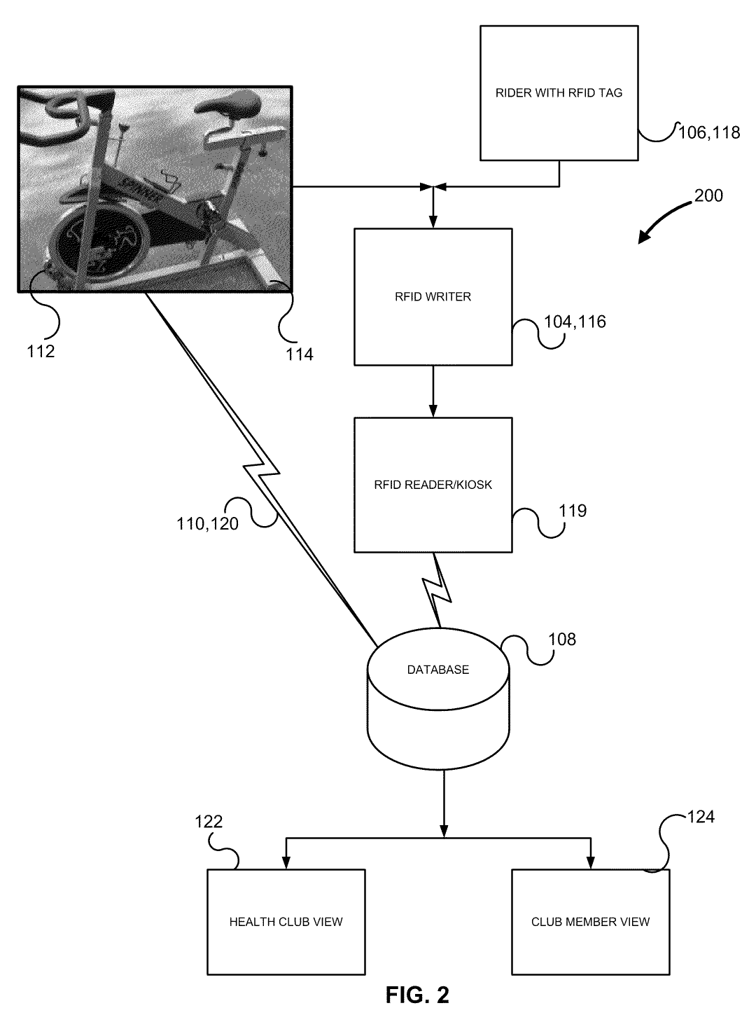

Referring now to FIG. 2, some embodiments include a system 200 that is similar to system 100 but differs in that data from electricity generation unit 112 is not sent to radio frequency identification tag 118. Rather, a user's unique identification code is sent from radio frequency identification tag 118 to electricity generation unit 112 and associated with the data related to the energy being generated. When the user is finished using the equipment, both the data related to the energy being generated and the associated unique identification code of the user that generated the energy are transmitted to database 108.

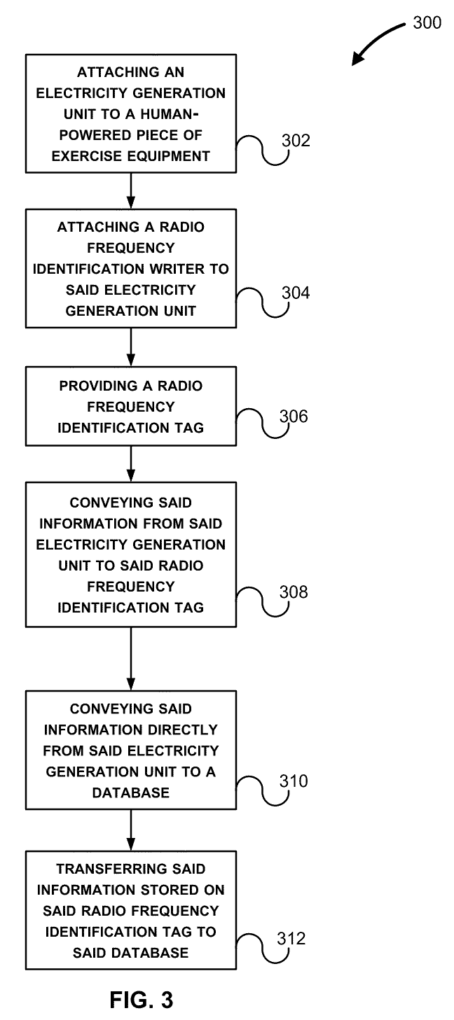

Referring now to FIG. 3, some embodiments include a method 300 of capturing and reporting information related to the micro-generation of consumable electricity. At 302, an electricity generation unit is attached to a human-powered piece of exercise equipment. The electricity generation unit is adapted to generate consumable energy and capture information related to the consumable electricity generated. At 304, a radio frequency identification writer is attached to the electricity generation unit for capturing and conveying information related to the consumable electricity generated by the electricity generation unit. At 306, a radio frequency identification tag is provided to a user. At 308, information from the electricity generation unit is conveyed to the radio frequency identification tag via the radio frequency identification writer. The information stored on the radio frequency identification tag typically includes Equipment ID, Start and End time of workout, Total energy produced, and peak energy produced during workout. The information can be from a single workout or from a plurality of workouts. In some embodiments, the information captured by the radio frequency identification tag is erased from the radio frequency identification tag after it is conveyed to the database. At 310, information is conveyed directly from the electricity generation unit to the database. In this way, aggregate data for all of the users of a particular health club can be gathered periodically or in real time. The information conveyed directly from the electricity generation unit to a database generally includes total energy production and real-time energy production. Typically, the information captured by the electricity generation unit is erased from the electricity generation unit after it is conveyed to the database. At 312, the information stored on the radio frequency identification tag is transferred to the database. In some embodiments, the radio frequency identification tag is scanned using a tag reader thereby conveying all of the information on the radio frequency identification tag to the reader. The scanned information is then electronically or otherwise transmitted to the database.

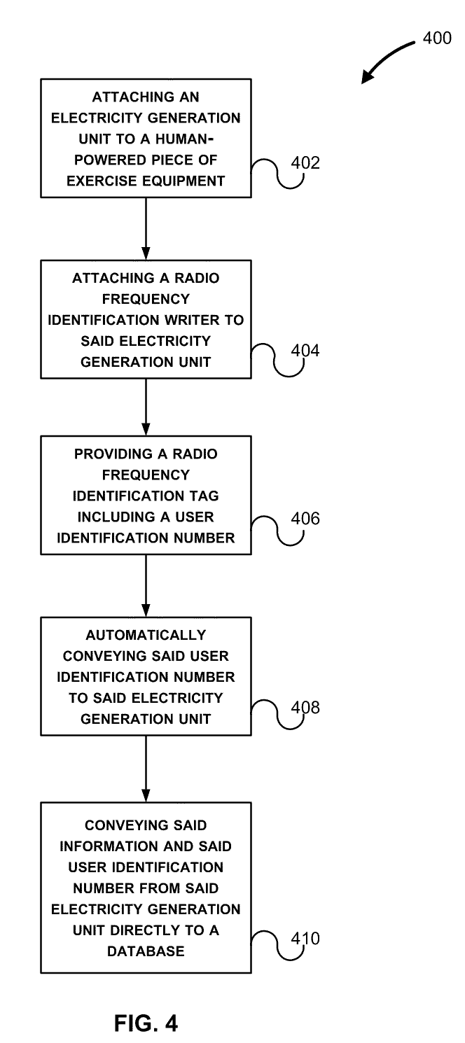

Referring now to FIG. 4, some embodiments include a method 400 of capturing and reporting information related to the micro-generation of consumable electricity. At 402, an electricity generation unit is attached to a human-powered piece of exercise equipment. The electricity generation unit is adapted to generate consumable energy and capture information related to the consumable electricity generated. At 404, a radio frequency identification writer is attached to the electricity generation unit for capturing and conveying information related to the consumable electricity generated by the electricity generation unit. At 406, a radio frequency identification tag including a user identification number is provided to a user. At 408, the user identification number is automatically conveyed to the electricity generation unit via the radio frequency identification writer. At 410, the information and the user identification number from the electricity generation unit are conveyed directly to a database.

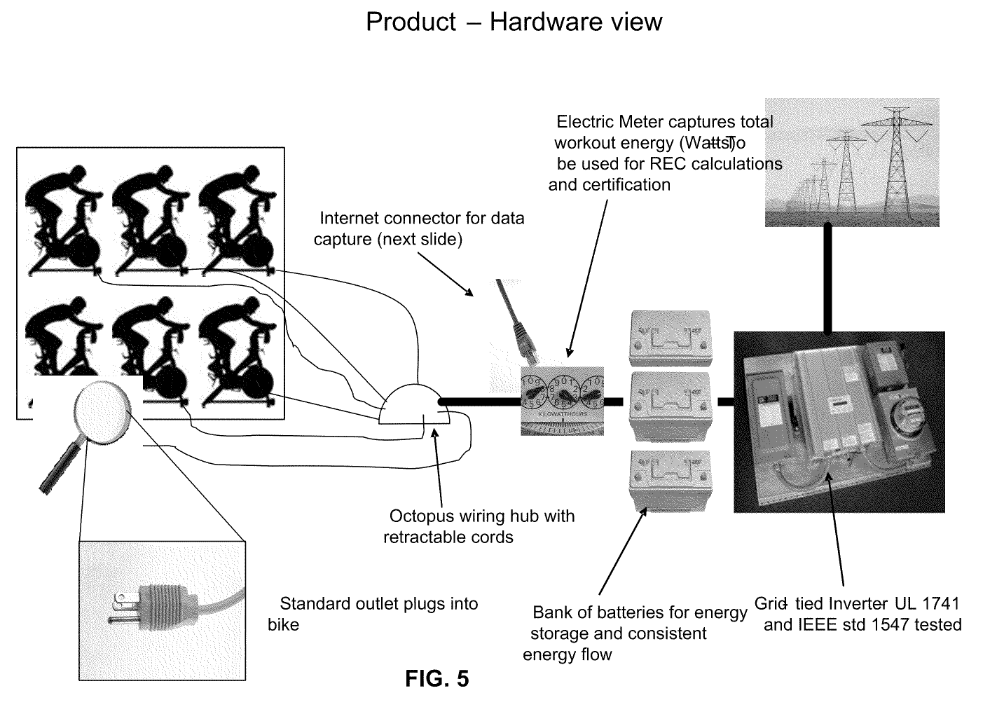

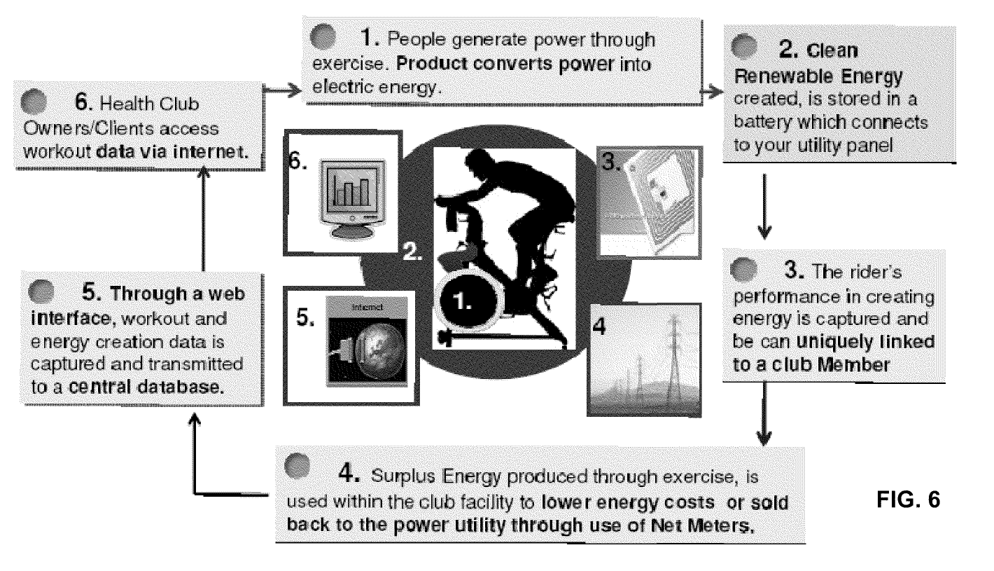

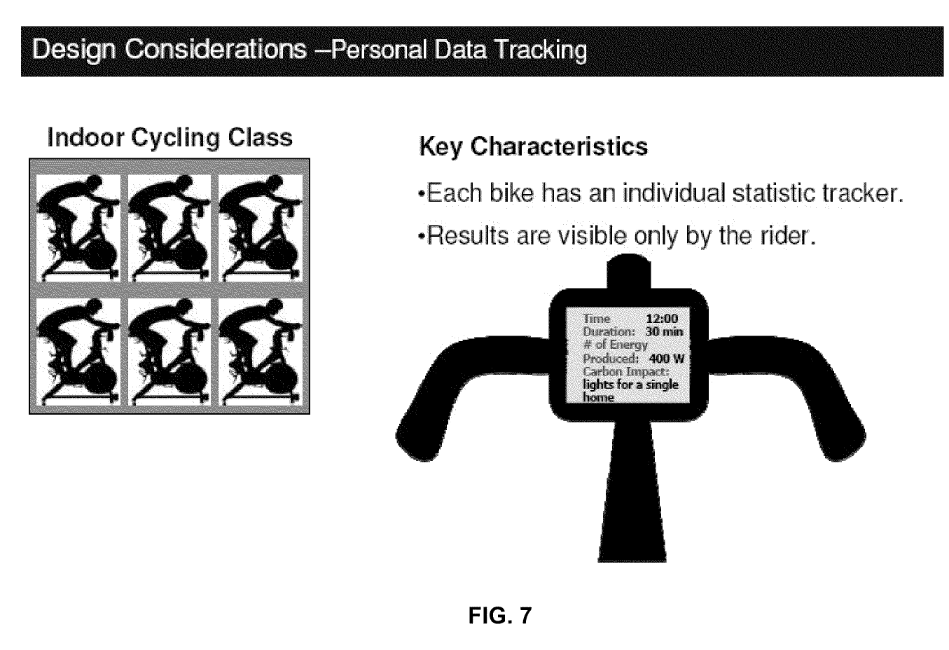

Referring now to FIGS. 5-7 illustrate embodiments of the disclosed subject matter. In FIG. 5, energy generated by and collected from a group of exercise equipment, e.g., a plurality of exercise bikes. The energy is aggregated and passed through an electric meter for measurement. Data related to the energy collected is captured and transmitted via the Internet. FIG. 6 illustrates an overview of systems and methods according to the disclosed subject matter. People generate power through exercise. The power is converted into electrical energy. As a result, clean renewable energy is created and stored in batteries, which connects to a utility panel. The user's performance in creating energy is captured and can be uniquely linked to a health club member. Surplus energy produced through exercise is used within the club facility to lower energy costs or is sold back to the power utility through the use of Net Meters. Through a web interface, workout and energy creation data is captured and transmitted to a central database. Health club owners and club members can access the workout and energy data via the Internet. FIG. 7 illustrates a user interface that can provide energy-related data to a user during a workout. For example, each exercise bike could display information to a user related to the energy produced and its carbon impact, e.g., enough energy produced to light a home for 1 hour, etc.

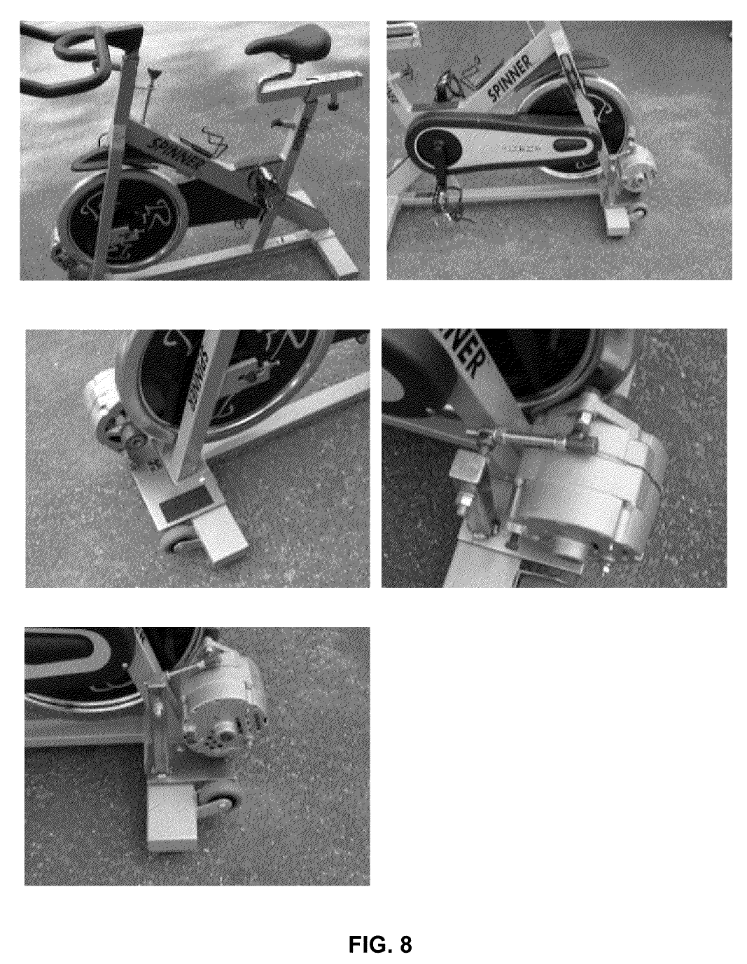

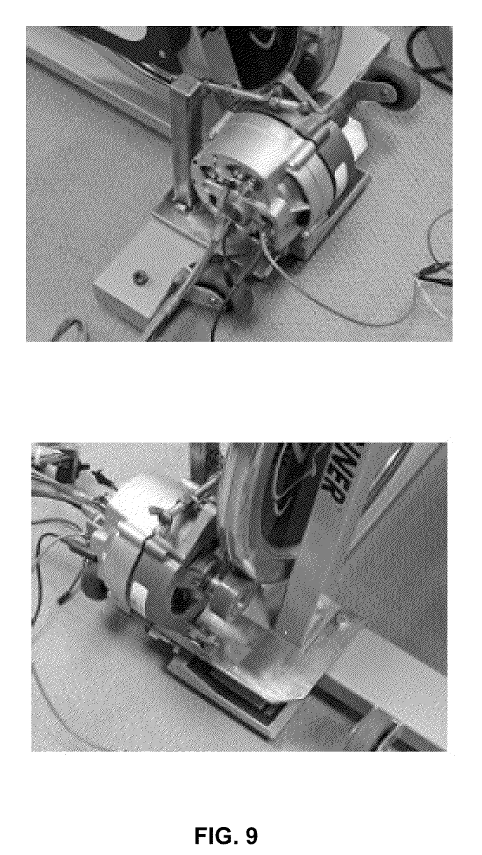

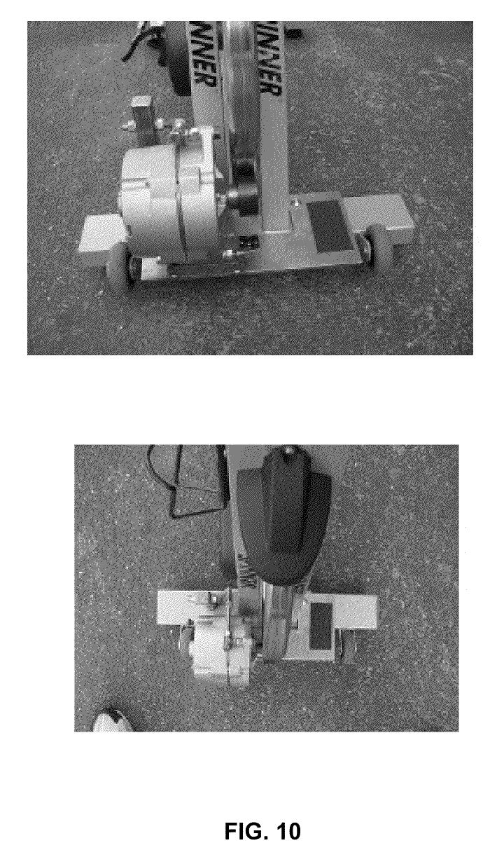

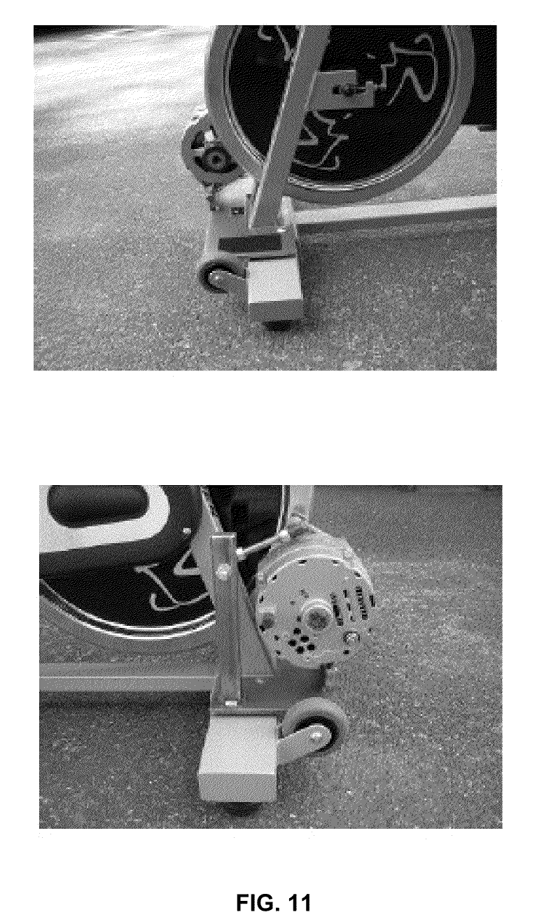

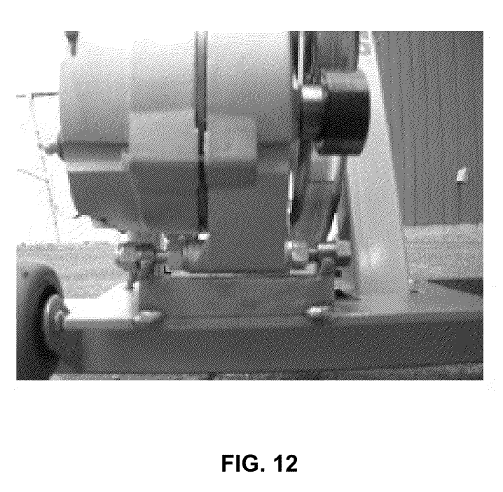

Referring now to FIGS. 8-12, some embodiments of the disclosed subject matter included an electricity generation unit for attachment to a stationary bicycle, e.g., a spinning bike. An alternator can be coupled to the wheel that revolves. Specially sized Drive Rollers can be used to couple the alternator to the revolving wheel to maximize gear ratio/power output. The friction level of the alternator to the revolving wheel can be maintained via a tension screw attached to the assembly frame of the bicycle. The energy output of the alternator can be regulated through a heavy-duty marine/RV (recreation vehicle) battery, which acts as a capacitor to smooth the sometimes variable output of the alternator due in part to the inability of an operator to maintain a constant output of RPM (revolutions per minute). The battery can be further connected to a 1000 watt DC (direct current) to AC (alternating current) inverter in order to produce an electrical output that can be used by most modern appliances operating on household electrical current.

The disclosed subject matter offers advantages and benefits over known systems. The integrated information system is essential to the overall utilization of the produced electrical energy output. Since the electricity-generating exercise equipment is used to create clean, renewable energy for use in the facility in which it operates, as well as sold back to the electric utility, the information system captures information regarding power output and calculates any amount that is in excess of the needs of the facility through the use of Net Metering.

Electrical output will also be used to capture Renewable Energy Certificates, which can be traded on the open market for those companies wishing to purchase clean energy. Calculations of CO2 savings can be recorded on an individual user basis as well as on an equipment basis, allowing both individuals and facilities (such as fitness centers) to report the amount of carbon footprint reduction attained by using the electricity-generating exercise equipment.

The information system captures information related to the measurement of generated electrical output. Such excess power output can be sold back to the electric utility through the use of Net Metering. The information system may also provide a monitoring system for the capture of Renewable Energy Certificates, which can be traded on the open market for those companies wishing to purchase clean energy. The information system captures and stores cumulative data from both the perspective of the rider and the perspective of the bicycle. Although the disclosed subject matter has been described and illustrated with respect to embodiments thereof, it should be understood by those skilled in the art that features of the disclosed embodiments can be combined, rearranged, etc., to produce additional embodiments within the scope of the invention, and that various other changes, omissions, and additions may be made therein and thereto, without parting from the spirit and scope of the present invention.

What is claimed is:

1. A method of capturing and reporting information related to the micro-generation of consumable electricity, said method comprising:
attaching an electricity generation unit to a human-powered piece of exercise equipment, said electricity generation unit being adapted to generate consumable energy and capture information related to the consumable electricity generated;
attaching a radio frequency identification writer to said electricity generation unit for capturing and conveying information related to the consumable electricity generated by said electricity generation unit;
providing a radio frequency identification tag;
conveying said information from said electricity generation unit to said radio frequency identification tag via said radio frequency identification writer;
conveying said information directly from said electricity generation unit to a database; and
transferring said information stored on said radio frequency identification tag to said database.

2. A method according to claim 1, wherein said information captured by said electricity generation unit is erased from said electricity generation unit after it is conveyed to said database.

3. A method according to claim 1, wherein said information captured by said radio frequency identification tag is erased from said radio frequency identification tag after it is conveyed to said database.

4. A method according to claim 1, wherein said information stored on said radio frequency identification tag includes Equipment ID, Start and End time of workout, Total energy produced, and peak energy produced during workout.

5. A method according to claim 1, further comprising:
scanning said radio frequency identification tag using a tag reader thereby conveying all of said information on said radio frequency identification tag to said reader; and
electronically transmitting said information in said reader to said database.

6. A method according to claim 5, wherein said information includes information from a plurality of workouts.

7. A method according to claim 1, wherein said information conveyed directly from said electricity generation unit to a database includes total energy production and real-time energy production.

8. A method of capturing and reporting information related to the micro-generation of consumable electricity, said method comprising:
attaching an electricity generation unit to a human-powered piece of exercise equipment, said electricity generation unit being adapted to generate consumable energy and capture information related to the consumable electricity generated;
attaching a radio frequency identification writer to said electricity generation unit for capturing and conveying information related to the consumable electricity generated by said electricity generation unit;
providing a radio frequency identification tag including a user identification number;
automatically conveying said user identification number to said electricity generation unit via said radio frequency identification writer; and
conveying said information and said user identification number from said electricity generation unit directly to a database.

9. A method according to claim 8, wherein said information captured by said electricity generation unit is erased from said electricity generation unit after it is conveyed to said database.

10. A method according to claim 8, wherein said information captured by said radio frequency identification tag is erased from said radio frequency identification tag after it is conveyed to said database.

11. A method according to claim 8, wherein said information stored on said radio frequency identification tag includes Equipment ID, Start and End time of workout, Total energy produced, and peak energy produced during workout.

12. A method according to claim 8, further comprising:
scanning said radio frequency identification tag using a tag reader thereby conveying all of said information on said radio frequency identification tag to said reader; and
electronically transmitting said information in said reader to said database.

13. A method according to claim 12, wherein said information includes information from a plurality of workouts.

14. A method according to claim 8, wherein said information conveyed directly from said electricity generation unit to a database includes total energy production and real-time energy production.

15. A system for capturing and reporting information related to the micro-generation of consumable electricity, said system comprising:
an energy generation module including an electricity generation unit joined with a human-powered piece of exercise equipment, said electricity generation unit being adapted to generate consumable electricity and capture information related to the consumable electricity generated;
a data capture module including a radio frequency identification writer joined with said electricity generation unit, said radio frequency identification writer being used to capture and convey information related to the consumable electricity generated by said electricity generation unit;
an individual user data module including a radio frequency identification tag to be associated with an individual user, said radio frequency identification tag being adapted to receive information from said electricity generation unit via said radio frequency identification writer;
a database for receiving said information stored on said radio frequency identification tag; and
a direct reporting module including a communication conduit for conveying said information directly from said electricity generation unit to said database.

16. A system according to claim 15, wherein said information captured by said electricity generation unit is erased from said electricity generation unit after it is conveyed to said database.

17. A system according to claim 15, wherein said information captured by said radio frequency identification tag is erased from said radio frequency identification tag after it is conveyed to said database.

18. A system according to claim 15, wherein said information stored on said radio frequency identification tag includes Equipment ID, Start and End time of workout, Total energy produced, and peak energy produced during workout.

19. A system according to claim 15, further comprising:
a scanning module including a tag reader for scanning said radio frequency identification tag using to convey all of said information on said radio frequency identification tag to said reader and electronically transmitting said information in said reader to said database.

20. A system according to claim 15, wherein said information conveyed directly from said electricity generation unit to a database includes total energy production and real-time energy production.
